(19) United States
(12) Patent Application Publication
(10) Pub. No.: US 2025/0245552 A1
(43) Pub. Date: Jul. 31, 2025

(54) LEARNING RATE SCHEDULE FOR TRAINING MACHINE LEARNING BASED LANGUAGE MODELS

(71) Applicant: Databricks, Inc., San Francisco, CA (US)

(72) Inventor: Mansheej Paul, New York, NY (US)

(21) Appl. No.: 18/424,774

(22) Filed: Jan. 27, 2024

(51) Int. Cl. G06N 20/00

(52) U.S. Cl. CPC G06N 20/00

(57) ABSTRACT

A system trains a machine learning model, such as a language model for a set of iterations using a learning rate that is a piecewise function comprising: (1) a first range of inputs for which the learning rate is linearly increasing in value with the number of iterations, (2) a second range of inputs after the first range of inputs for which the learning rate comprises: a first term that varies as inverse square root of the number of iterations, and a second term that has a constant value with respect to the number of iterations, and (3) a third range of inputs for which the learning rate is linearly decreasing in value with the number of iterations. The system evaluates the trained language model and determines based on the evaluation, whether the trained language model should be deployed.

### TECHNICAL FIELD

The disclosed configuration relates generally to training of machine learning models, and more particularly to determining learning rate for training machine learning models such as language models.

### BACKGROUND

State of the machine learning models are highly complex. For example, large language models (LLMs) have several hundred billion parameters. As a result, machine learning model training can be costly and time intensive. Training such models places high computational demand to perform complex operations and process large volumes of data efficiently. Machine learning models are typically trained by iteratively executing the machine learning models on significant amount of training data a large volume of data and adjusting the model parameters, making this process computationally intensive. Machine learning models such as large language models are periodically re-trained as new training data becomes available. Certain hyperparameters such as the learning rate has significant impact on the effectiveness of the training process. Tuning the learning rate affects the speed and quality of model training. Improper determination of the learning rate hyperparameter can significantly degrade the performance and effectiveness of the training process.

### SUMMARY

A system trains a machine learning model, such as a language model, for several iterations until the model performance is evaluated to be satisfactory. The system determines the learning rate such that the training process is computationally efficient if the model needs to be retrained with additional training data. Although the techniques are described using training of a language model, the techniques disclosed apply to other types of machine learning models.

The system receives a training data set for training the language model. The system determines a number of iterations for which the machine learning model should be trained. The system initializes parameters of the language model. The system repeatedly trains the language model for a set of iterations using a learning rate that varies with iterations. Accordingly, the learning rate is a piecewise function comprising: (1) a first range of inputs for which the learning rate is linearly increasing in value with the number of iterations, (2) a second range of inputs after the first range of inputs for which the learning rate comprises: a first term that varies as inverse square root of the number of iterations, and a second term that has a constant value with respect to the number of iterations, and (3) a third range of inputs for which the learning rate is linearly decreasing in value with the number of iterations. Accordingly the system trains the language model for (1) a first set of iterations for which the learning rate is linearly increasing in value with the number of iterations, (2) a second set of iterations after the first set of iterations, for which the learning rate comprises the first term and the second term, and (3) a third set of iterations after the second set of iterations for which the learning rate is linearly decreasing in value with the number of iterations. The system evaluates the trained language model and determines based on the evaluation, whether the trained language model should be deployed.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a system environment for a data processing service, in accordance with an embodiment.

FIG. 2 is a block diagram of an architecture of a data storage system 108, in accordance with an embodiment.

FIG. 3 is a block diagram of an architecture of a control layer 106, in accordance with an embodiment.

FIG. 4 is a block diagram of an architecture of a cluster computing system 402 of the data layer 108, in accordance with an embodiment.

FIG. 5 is a block diagram of an architecture of a driver node 450, in accordance with an embodiment.

FIG. 6 further describes the system architecture of the model training module according to an embodiment.

FIG. 7A illustrates the learning rate as a function over time wherein the learning rate is a function of α over a time t.

FIG. 7B also illustrates the learning rate as a function over time wherein the learning rate is a function of α over a time t.

FIG. 8 is a flowchart of a method for a model training module 560, in accordance with an embodiment.

FIG. 9 further describes the embodiment where the model is repeatedly trained in accordance with an embodiment.

FIG. 10 is an example machine to read and execute computer readable instructions, in accordance with an embodiment.

### DETAILED DESCRIPTION

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The learning rate is a hyperparameter in the model training process that determines a step size at each iteration while minimizing a loss function. The learning rate determines the step size to minimize the loss function over a set of iterations. Accordingly, the learning rate influences the convergence speed of the loss function. If the learning rate is too large, the model may converge more quickly but may also overshoot and may never converge toward the optimal minimum loss solution. If the learning rate is too small, the model may not converge or may take too long to converge towards the optimal solution.

Certain machine learning models, for example, language models are retrained multiple times. Language models are trained multiple times to fine-tune for the model using newer training data that is available. This creates an issue for re-training language models as current methods require language models to re-train by re-teaching the model with a linearly increasing learning rate and an inversely decreasing linear rate. Conventional techniques decrease the learning rate to a very small value close to the end of the training process. If the model needed to be trained further, for example, based on the evaluation of the model, training using a small learning rate would either require a large number of training steps or it would result in very little change of the model parameters. Alternatively, retraining the machine learning model may be performed by restarting the training process from an earlier version of the machine learning model, thereby discarding significant amount of effort spent in training the model. As a result, approaches based on conventional techniques either are computationally inefficient or generate a model that has poor performance. In contrast, the techniques disclosed herein allow retraining of the machine learning model without requiring the system to discard large amount of processing effort used in training the model while still maintaining proper step size that results in improvement of model performance. This significantly decreases the total training time when fine-tuning a language model. In some embodiments, the configurable hyperparameter with the determined minimum learning rate reduces total training time by at least 50%.

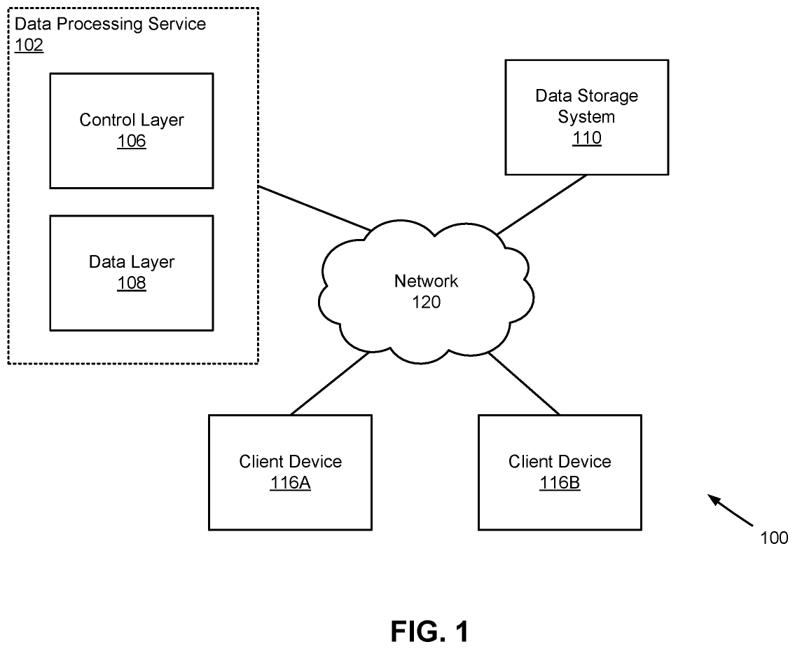

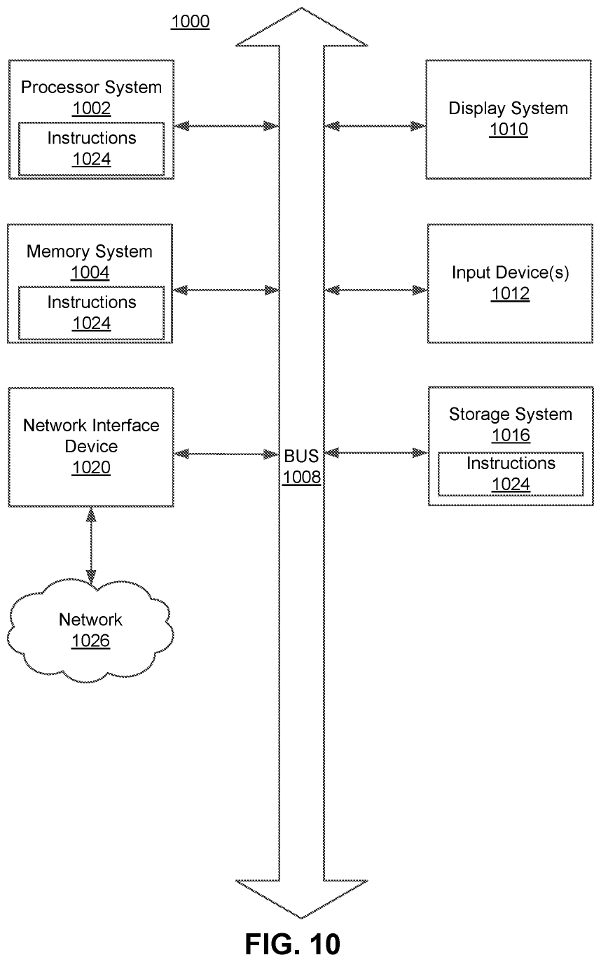

FIG. 1 is a high-level block diagram of a system environment 100 for a data processing service 102, in accordance with an embodiment. The system environment 100 shown by FIG. 1 includes one or more client devices 116A, 116B, a network 120, a data processing service 102, and a data storage system 110. In alternative configurations, different and/or additional components may be included in the system environment 100. The computing systems of the system environment 100 may include some or all of the components (systems (or subsystems)) of a computer system 1000 as described with FIG. 10.

The data processing service 102 is a service for managing and coordinating data processing services (e.g., database services) to users of client devices 116. The data processing service 102 may manage one or more applications that users of client devices 116 can use to communicate with the data processing service 102. Through an application of the data processing service 102, the data processing service 102 may receive requests (e.g., database queries) from users of client devices 116 to perform one or more data processing functionalities on data stored, for example, in the data storage system 110. The requests may include query requests, analytics requests, or machine learning and artificial intelligence requests, and the like, on data stored by the data storage system 110. The data processing service 102 may provide responses to the requests to the users of the client devices 116 after they have been processed.

The data processing service 102 may prepare data for model training to train a machine learning model. The data processing service 102 may perform model training for machine learning models such as language models, image processing models, speech recognition models, and recommendation models. The data processing service 102 collects, cleans, and processes the raw data to prepare for machine learning analysis. The data processing service 102 selects relevant features or attributes from the selected data to train the machine learning model. Further, the data processing service 102 selects an appropriate machine learning model for a desired solution. The data processing service 102 trains the model using the cleaned and processed data and adjusts a model's hyperparameters to analyze and evaluate the model. In a further step, the data processing service 102 additionally fine tunes the hyper parameters to refine the settings of the model to optimize model performance. In a further step, the data processing service 102 monitors and updates the model to evaluate the performance of a model.

In one embodiment, as shown in the system environment 100 of FIG. 1, the data processing service 102 includes a control layer 106 and a data layer 108. The components of the data processing service 102 may be configured by one or more servers and/or a cloud infrastructure platform. In one embodiment, the control layer 106 receives data processing requests and coordinates with the data layer 108 to process the requests from client devices 116. The control layer 106 may schedule one or more jobs for a request or receive requests to execute one or more jobs from the user directly through a respective client device 116. The control layer 106 may distribute the jobs to components of the data layer 108 where the jobs are executed.

The control layer 106 is additionally capable of configuring the clusters in the data layer 108 that are used for executing the jobs. For example, a user of a client device 116 may submit a request to the control layer 106 to perform one or more queries and may specify that four clusters on the data layer 108 be activated to process the request with certain memory requirements. Responsive to receiving this information, the control layer 106 may send instructions to the data layer 108 to activate the requested number of clusters and configure the clusters according to the requested memory requirements.

The control layer 106 manages the training of the machine learning models and notably determines the learning rate for the machine learning model. The control layer 106 includes a component for handling hyperparameter fine tuning and model retraining to refine the settings of the model to optimize model performance.

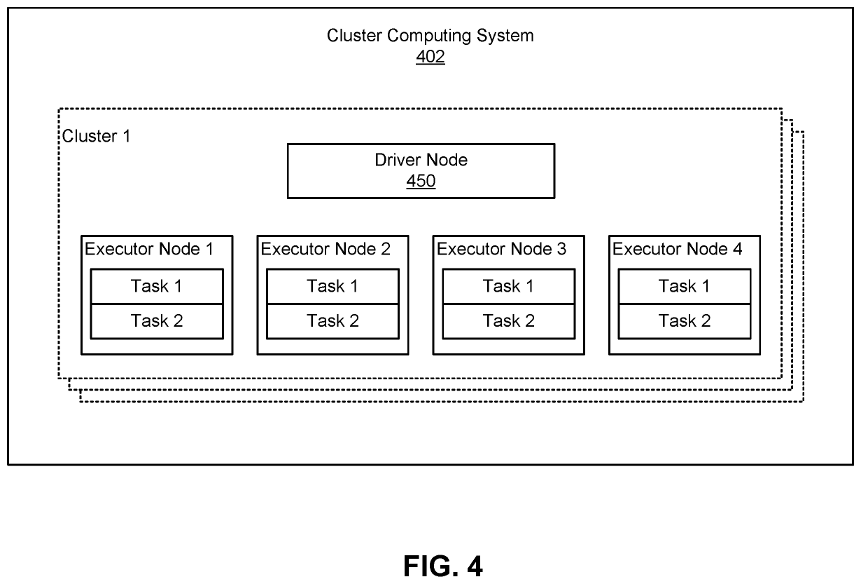

The data layer 108 includes multiple instances of clusters of computing resources that execute one or more jobs received from the control layer 106. Accordingly, the data layer 108 may include a cluster computing system for executing the jobs. An example of a cluster computing system is described in relation to FIG. 4. In one instance, the clusters of computing resources are virtual machines or virtual data centers configured on a cloud infrastructure platform. In one instance, the control layer 106 is configured as a multi-tenant system and the data layers 108 of different tenants are isolated from each other. In one instance, a serverless implementation of the data layer 108 may be configured as a multi-tenant system with strong virtual machine (VM) level tenant isolation between the different tenants of the data processing service 102. Each customer represents a tenant of a multi-tenant system and shares software applications and also resources such as databases of the multi-tenant system. Each tenant's data is isolated and remains invisible to other tenants. For example, a respective data layer instance can be implemented for a respective tenant. However, it is appreciated that in other embodiments, single tenant architectures may be used.

The data layer 108 thus may be accessed by, for example, a developer through an application of the control layer 106 to execute code developed by the developer. In one embodiment, a cluster in a data layer 108 may include multiple worker nodes that execute multiple jobs in parallel. Responsive to receiving a request, the data layer 108 divides the cluster computing job into a set of worker jobs, provides each of the worker jobs to a worker node, receives worker job results, stores job results, and the like. The data layer 108 may include resources not available to a developer on a local development system, such as powerful computing resources to process very large data sets. In this manner, when the data processing request can be divided into jobs that can be executed in parallel, the data processing request can be processed and handled more efficiently with shorter response and processing time.

The data storage system 110 includes a device (e.g., a disc drive, a hard drive, a semiconductor memory) used for storing database data (e.g., a stored data set, portion of a stored data set, data for executing a query). In one embodiment, the data storage system 110 includes a distributed storage system for storing data and may include a commercially provided distributed storage system service. Thus, the data storage system 110 may be managed by a separate entity than an entity that manages the data processing service 102 or the data management system 110 may be managed by the same entity that manages the data processing service 102.

The data storage system 110 stores the raw data as well as the training data which the machine learning model is trained on.

The client devices 116 are computing devices that display information to users and communicates user actions to the systems of the system environment 100. While two client devices 116A, 116B are illustrated in FIG. 1, in practice many client devices 116 may communicate with the systems of the system environment 100. In one embodiment, client devices 116 of the system environment 100 may include some or all of the components (systems (or subsystems)) of a computer system 1000 as described with FIG. 10.

In one embodiment, a client device 116 executes an application allowing a user of the client device 116 to interact with the various systems of the system environment 100 of FIG. 1. For example, a client device 116 can execute a browser application to enable interaction between the client device 116 and the data processing system 106 via the network 120. In another embodiment, the client device 116 interacts with the various systems of the system environment 100 through an application programming interface (API) running on a native operating system of the client device 116, such as IOS® or ANDROID™.

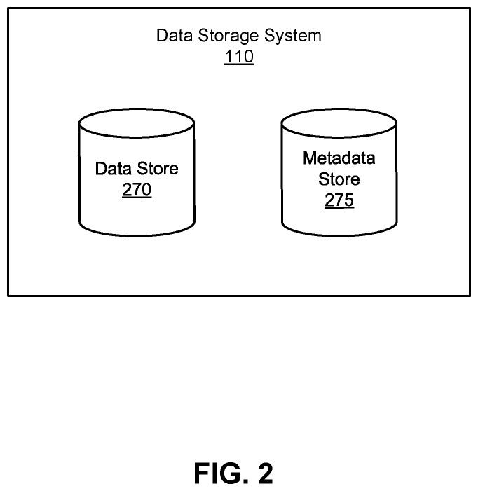

FIG. 2 is a block diagram of an architecture of a data storage system 108, in accordance with an embodiment. In one embodiment, the data storage system 108 includes a data ingestion module 250. The data storage system 108 also includes a data tables store 270 and a metadata store 275.

The data store 270 stores data associated with different tenants of the data processing service 102. In one embodiment, the data in data store 270 is stored in a format of a data table. A data table may include a plurality of records or instances, where each record may include values for one or more features. The records may span across multiple rows of the data table and the features may span across multiple columns of the data table. In other embodiments, the records may span across multiple columns and the features may span across multiple rows. For example, a data table associated with a security company may include a plurality of records each corresponding to a login instance of a respective user to a website, where each record includes values for a set of features including user login account, timestamp of attempted login, whether the login was successful, and the like. In one embodiment, the plurality of records of a data table may span across one or more data files. For example, a first subset of records for a data table may be included in a first data file and a second subset of records for the same data table may be included in another second data file.

In one embodiment, a data table may be stored in the data store 270 in conjunction with metadata stored in the metadata store 275. In one instance, the metadata includes transaction logs for data tables. Specifically, a transaction log for a respective data table is a log recording a sequence of transactions that were performed on the data table. A transaction may perform one or more changes to the data table that may include removal, modification, and additions of records and features to the data table, and the like. For example, a transaction may be initiated responsive to a request from a user of the client device 116. As another example, a transaction may be initiated according to policies of the data processing service 102. Thus, a transaction may write one or more changes to data tables stored in the data storage system 110.

In one embodiment, a new version of the data table is committed when changes of a respective transaction are successfully applied to the data table of the data storage system 108. Since a transaction may remove, modify, or add data files to the data table, a particular version of the data table in the transaction log may be defined with respect to the set of data files for the data table. For example, a first transaction may have created a first version of a data table defined by data files A and B each having information for a respective subset of records. A second transaction may have then created a second version of the data table defined by data files A, B and in addition, new data file C that include another respective subset of records (e.g., new records) of the data table.

In one embodiment, the transaction log may record each version of the table, the data files associated with a respective version of the data table, information pertaining to the type of transactions that were performed on the data table, the order in which the transactions were performed (e.g., transaction sequence number, a timestamp of the transaction), and an indication of data files that were subject to the transaction, and the like. In some embodiments, the transaction log may include change data for a transaction that also records the changes for data written into a data table with respect to the previous version of the data table. The change data may be at a relatively high level of granularity, and may indicate the specific changes to individual records with an indication of whether the record was inserted, deleted, or updated due to the corresponding transaction.

In one embodiment, the transaction log for a data table in the metadata store 275 includes one or more log files (e.g., JSON files) that capture a transaction to the data table. A log file may include details of one or more transactions made to a respective set of data files of the data table. For example, the log may include the name of the data file, statistics of the data file including min-max ranges for a set of keys, size of the data file, type of transaction (e.g., write, add, update) committed, and the like. The metadata store 275 may also store one or more checkpoint files for the data table. Specifically, a set of checkpoint files describes the state of a data table at a given point in time by analyzing the transactions recorded in the log files until that time. Therefore, metadata for a data table may be characterized by a set of checkpoint files and one or more log files that describe transactions to the data table committed after the set of checkpoint files were created.

The data storage system 110 stores the cleaned and processed training data. The metadata store 275 stores the model parameters for which the machine learning model is trained upon. The metadata store 275 also stores any hyperparameters used by the machine learning model, for example, the learning rate.

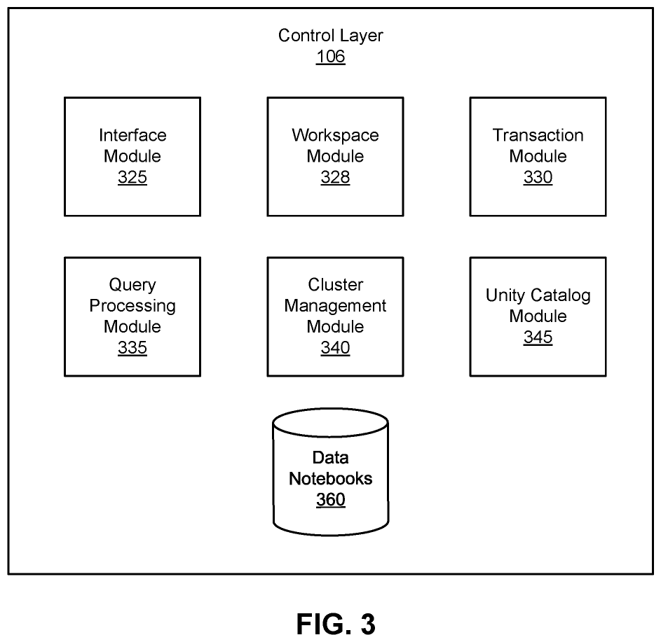

FIG. 3 is a block diagram of an architecture of a control layer 106, in accordance with an embodiment. In one embodiment, the data processing system 106 includes an interface module 325, a transaction module 330, a query processing module 335, and a cluster management module 340. The control layer 106 also includes a data notebook store 360. The modules 325, 330, 335, and 340 may be structured for execution by a computer system, e.g., 1000 having some or all of the components as described in FIG. 10, such that the computer system 1000 operates in a specified manner as per the described functionality.

The interface module 325 provides an interface and/or a workspace environment where users of client devices 116 (e.g., users associated with tenants) can access resources of the data processing service 102. For example, the user may retrieve information from data tables associated with a tenant, submit data processing requests such as query requests on the data tables, through the interface provided by the interface module 325. The interface provided by the interface module 325 may include notebooks, libraries, experiments, queries submitted by the user. In one embodiment, a user may access the workspace via a user interface (UI), a command line interface (CLI), or through an application programming interface (API) provided by the workspace module 325.

For example, a notebook associated with a workspace environment is a web-based interface to a document that includes runnable code, visualizations, and explanatory text. A user may submit data processing requests on data tables in the form of one or more notebook jobs. The user provides code for executing the one or more jobs and indications such as the desired time for execution, number of cluster worker nodes for the jobs, cluster configurations, a notebook version, input parameters, authentication information, output storage locations, or any other type of indications for executing the jobs. The user may also view or obtain results of executing the jobs via the workspace.

The workspace module 328 deploys workspaces within the data processing service 102. A workspace as defined herein may refer to a deployment in the cloud that functions as an environment for users of the workspace to access assets. An account of the data processing service 102 represents a single entity that can include multiple workspaces. In one embodiment, an account associated with the data processing service 102 may be associated with one workspace. In another embodiment, an account may be associated with multiple workspaces. A workspace organizes objects, such as notebooks, libraries, dashboards, and experiments into folders. A workspace also provides users access to data objects, such as tables or views or functions, and computational resources such as cluster computing systems.

In one embodiment, a user or a group of users may be assigned to work in a workspace. The users assigned to a workspace may have varying degrees of access permissions to assets of the workspace. For example, an administrator of the data processing service 102 may configure access permissions such that users assigned to a respective workspace are able to access all of the assets of the workspace. As another example, users associated with different subgroups may have different levels of access, for example users associated with a first subgroup may be granted access to all data objects while users associated with a second subgroup are granted access to only a select subset of data objects.

The transaction module 330 receives requests to perform one or more transaction operations from users of client devices 116. As described in conjunction in FIG. 2, a request to perform a transaction operation may represent one or more requested changes to a data table. For example, the transaction may be to insert new records into an existing data table, replace existing records in the data table, delete records in the data table. As another example, the transaction may be to rearrange or reorganize the records or the data files of a data table to, for example, improve the speed of operations, such as queries, on the data table. For example, when a particular version of a data table has a significant number of data files composing the data table, some operations may be relatively inefficient. Thus, a transaction operation may be a compaction operation that combines the records included in one or more data files into a single data file.

The query processing module 335 receives and processes queries that access data stored by the data storage system 110. The query processing module 335 may reside in the control layer 106. The queries processed by the query processing module 335 are referred to herein as database queries. The database queries are specified using a declarative database query language such as the SQL. The query processing module 335 compiles a database query specified using the declarative database query language to generate executable code that is executed. The query processing module 335 may encounter runtime errors during execution of a database query and returns information describing the runtime error including an origin of the runtime error representing a position of the runtime error in the database query. In one embodiment, the query processing module 335 provides one or more queries to appropriate clusters of the data layer 108, and receives responses to the queries from clusters in which the queries are executed.

The unity catalog module 345 is a fine-grained governance solution for managing assets within the data processing service 102. It helps simplify security and governance by providing a central place to administer and audit data access. In one embodiment, the unity catalog module 345 maintains a metastore for a respective account. A metastore is a top-level container of objects for the account. The metastore may store data objects and the permissions that govern access to the objects. A metastore for an account can be assigned to one or more workspaces associated with the account. In one embodiment, the unity catalog module 345 organizes data as a three-level namespace, a catalogue is the first layer, a schema (also called a database) is the second layer, and tables and views are the third layer.

In one embodiment, the unity catalog module 345 enables read and write of data to data stored in cloud storage of the data storage system 110 on behalf of users associated with an account and/or workspace. In one instance, the unity catalog module 345 manages storage credentials and external locations. A storage credential represents an authentication and authorization mechanism for accessing data stored on the data storage system 110. Each storage credential may be subject to access-control policies that control which users and groups can access the credential. An external location is an object that combines a cloud storage path (e.g., storage path in the data storage system 110) with a storage credential that authorizes access to the cloud storage path. Each storage location is subject to access-control policies that control which users and groups can access the storage credential. Therefore, if a user does not have access to a storage credential in the unity catalog module 345, the unity catalog module 345 does not attempt to authenticate to the data storage system 110.

In one embodiment, the unity catalog module 345 allows users to share assets of a workspace and/or account with users of other accounts and/or workspaces. For example, users of Company A can configure certain tables owned by Company A that are stored in the data storage system 110 to be shared with users of Company B. Each organization may be associated with separate accounts on the data processing service 102. Specifically, a provider entity can share access to one or more tables of the provider with one or more recipient entities.

Responsive to receiving a request from a provider to share one or more tables (or other data objects), the unity catalog module 345 creates a share in the metastore of the provider. A share is a securable object registered in the metastore for a provider. A share contains tables and notebook files from the provider metastore that the provider would like to share with a recipient. A recipient object is an object that associates an organization with a credential or secure sharing identifier allowing that organization to access one or more shares of the provider. In one embodiment, a provider can define multiple recipients for a given metastore. The unity catalog module 345 in turn may create a provider object in the metastore of the recipient that stores information on the provider and the tables that the provider has shared with the recipient. In this manner, a user associated with a provider entity can securely share tables of the provider entity that are stored in a dedicated cloud storage location in the data storage system 110 with users of a recipient entity by configuring shared access in the metastore.

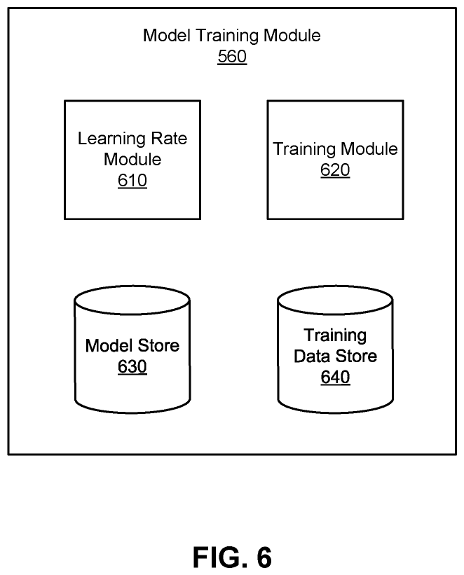

The model training module 560 may train a machine learning model for a particular machine learning task such as classification, regression, clustering, natural language processing, image recognition, or any other application of machine learning. FIG. 6 further describes the system architecture of the model training module 560. The machine learning models trained by the model training module 560 may be deployed for use by other modules of the data processing service, for example, data notebooks 360. Model training module 560 may interact with cluster management module 340 for training the machine learning model. For example, different processors may perform training of the machine learning model using different subsets of training data and may coordinate with each other to calculate the loss function or to evaluate the machine learning model.

FIG. 4 is a block diagram of an architecture of a cluster computing system 402 of the data layer 108, in accordance with an embodiment. In some embodiments, the cluster computing system 402 of the data layer 108 includes driver node 450 and worker pool including multiple executor nodes. The nodes may be structured for execution by a computer system, e.g., 1000 having some or all of the components as described in FIG. 10, such that the computer system 1000 operates in a specified manner as per the described functionality.

The driver node 450 receives one or more jobs for execution, divides a job into job stages, and provides job stages to executor nodes, receives job stage results from the executor nodes of the worker pool, and assembles job stage results into complete job results, and the like. In one embodiment, the driver node receives a request to execute one or more queries from the query processing module 335. The driver node 450 may compile a database query and generate an execution plan. The driver node 450 distributes the query information including the generated code to the executor nodes. The executor nodes execute the query based on the received information.

The worker pool can include any appropriate number of executor nodes (e.g., 4 executor nodes, 12 executor nodes, 256 executor nodes). Each executor node in the worker pool includes one or more execution engines (not shown) for executing one or more tasks of a job stage. In one embodiment, an execution engine performs single-threaded task execution in which a task is processed using a single thread of the CPU. The executor node distributes one or more tasks for a job stage to the one or more execution engines and provides the results of the execution to the driver node 410. According to an embodiment, an executor node executes the generated code for the database query for a particular subset of data that is processed by the database query. The executor nodes execute the query based on the received information from the driver node 450.

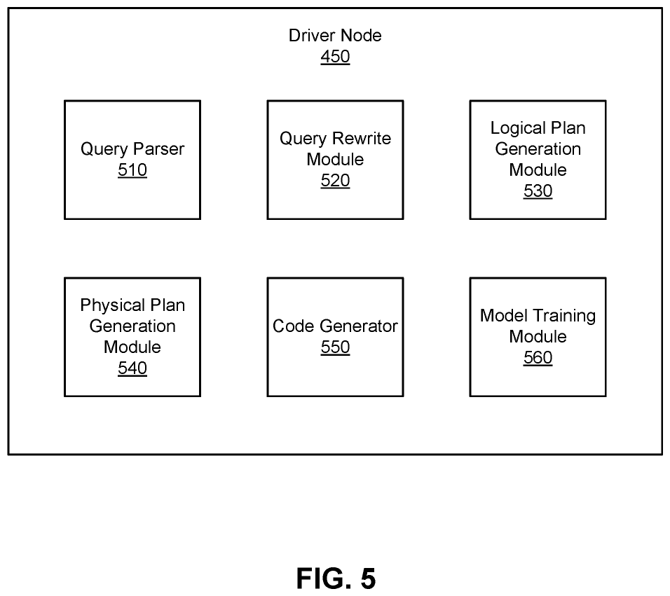

FIG. 5 is a block diagram of an architecture of a driver node 450, in accordance with an embodiment. In one instance, the driver node 450 includes a query parser 510, a query rewrite module 520, a logical plan generation module 530, a physical plan generation module 540, and a model training module 560. The modules and nodes may be structured for execution by a computer system, e.g., 1000 having some or all of the components as described in FIG. 10, such that the computer system 1000 operates in a specified manner as per the described functionality.

The query parser 510 receives a database query for processing and parses the database query. The database query is specified using a declarative database query language such as SQL. The query parser 510 parses the database query to identify various tokens of the database query and build a data structure representation of the database query. The data structure representation identifies various components of the database query, for example, any SELECT expressions that are returned by the database query, tables that are input to the query, a conditional clause of the database query, a group by clause, and so on. According to an embodiment, the data structure representation of the database query is a graph model based on the database query.

The query rewrite module 520 performs transformations of the database query, for example, to improve the execution of the query. The improvement may be in terms of execution time, memory utilization, or other resource utilization. A database query may process one or more tables that store a significant number of records that are processed by the database query. Since the declarative database query language does not specify the procedure for determining the result of the database query, there are various possible procedures for executing the database query.

The query rewrite module 520 may transform the query to change the order of processing of certain steps, for example, by changing the order in which tables are joined, by changing the order in which certain operations such as filtering of records of a table is performed in relation to other operations. The query rewrite module 520 may transform the database query to cause certain temporary results to be materialized. The query rewrite module 520 may eliminate certain operations if the operations are determined to be redundant. The query rewrite module 520 may transform a database query so that certain computations such as subqueries or expressions are shared. The query rewrite module 520 may transform the database query to pushdown certain computations, for example, by changing the order in which certain predicates are applied to the computation as early as possible. The query rewrite module 520 may transform the database query to modify certain predicates to use more optimized versions of the predicates that are computationally equivalent but provide better performance.

The logical plan generation module 530 generates a logical plan for the database query. The logical plan includes representation of the various steps that need to be executed for processing the database query. According to an embodiment, the logical plan generation module 530 generates an unresolved logical plan based on the transformed query graph representation. Various relation names (or table names) and column names may not be resolved in an unresolved logical plan. The logical plan generation module 530 generates a resolved logical plan from the unresolved logical plan by resolving the relation names and column names in the unresolved logical plan. The logical plan generation module 530 further optimizes the resolved logical plan to obtain an optimized logical plan.

The physical plan generation module 540 generates a physical plan from the logical plan generated by the logical plan generation module 530. The physical plan specifies details of how the logical plan is executed by the data processing service 102. The physical plan generation module 540 may generate different physical plans for the same logical plan and evaluate each physical plan using a cost model to select the optimal physical plan for execution. The physical plan further specifies details of various operations of the logical plan. As an example, if the logical plan includes a join operator, the physical plan may specify the type of join that should be performed for implementing the join operator. For example, the physical plan may specify whether the join operator should be implemented as a hash join, merge join, or sort join, and so on. The physical plan may be specific to a database system, whereas the logical plan may be independent of database systems and may be executed on any target database system by converting to a physical plan for that target database system.

The code generator 550 generates code representing executable instructions for implementing the physical plan for executing a database query. The generated code includes a set of instructions for each operator specified in the execution plan. The generated code is specified using a programming language that may be compiled and executed.

The model training module 560 determines a leaning rate. The model training module 560 trains a language model using available training data. Details of the model training module 560 are illustrated in FIG. 6 and described in connection with FIG. 6.

### System Architecture of Machine Learning Module

FIG. 6 shows the system architecture of a model training module 560, in accordance with a learning rate module 610, a training module 620, a model store 630, and a training data store 640.

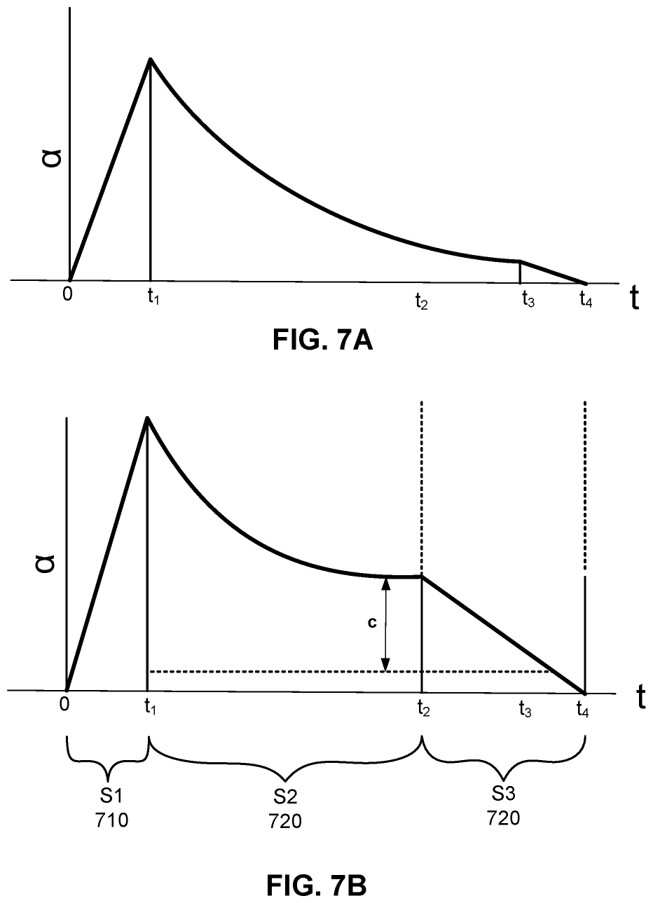

A learning rate module 610 determines a learning rate for a time step. The learning rate module 610 for a time t, determines the learning rate for training the language model. For a time t, the learning rate module 610 determines the learning rate at which the following for a timestep t. A set of iterations is defined as a range of timestep for a specified number of repetitive updates to a model's parameters during a single time step or iteration during the training process. For a first set of iterations S1, from a first-time step to a second time step, the learning rate module 610 determines a learning rate as a linear function of time t. For a second set of iterations S2 720 for a timestep t, from a second time step to a third time step, the learning rate module 610 determines the learning rate as an inversely decreasing and a constant value c function over the S2 720 set of iterations. For a third set of iterations S3 730, for a timestep t, from the second time step to a last time step, the learning rate module 610 determines the learning rate as a linearly decreasing function of time t. The learning rate module 610 determines for a time t within a total set of timesteps, the learning rate at which the model is training on. FIG. 7A and FIG. 7B graphically describes the learning rate as a function over the total set of timesteps.

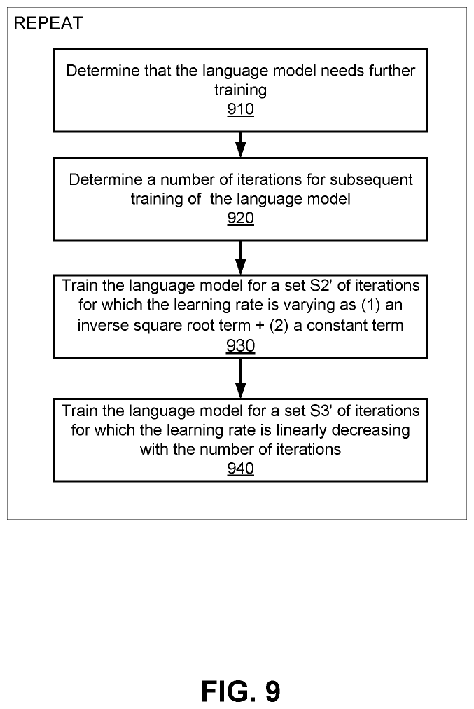

The training module 620 receives a training dataset for training the language model. The training dataset is a large collection of preprocessed and labeled text data to train the model and training the model to learn language patterns and associations for natural language processes. The training module 620 initializes weights and biases before training, providing a starting point for the optimization process. The training module 620 also initializes a total training time for a first iteration of training the language model. For the first iteration total training time over a time step t, the learning rate module 610 determines the learning rate for which the language model is trained upon. For a time step t, the model is repeatedly trained based on the learning rate determined by the learning rate module 610 for the first iteration total training time. Responsive to training the model for the total first iteration total training time, the model is evaluated to determine if it must be further retrained to improve model performance and model validity. In one embodiment, the training module 620 determines to retrain the model. The model may be repeatedly retrained with a learning rate determined by the learning rate module 610 for a subsequent total number of iterations for re-training the language model. FIG. 9 further describes the embodiment where the model is repeatedly trained. The training module 620 determines that the language model is to be deployed following a comprehensive evaluation of performance metrics and evaluates the loss function over a set of data.

The model store 630 receives the parameters of the language model. The model store 630 stores the parameters of the model and updates the parameters following the model training in the training module 620. As the training module 620 initializes the parameters of the model through initializing the parameters in the model store 630. As the training module 620 repeatedly fine-tunes the parameters, the model store 630 repeatedly updates the training weights and parameters determined.

The training data store 640 receives a set of training data for which the model is evaluated upon. The training data is data to train a machine learning model to allow for the model to learn patterns, relationships, and representations of the input features from the training dataset.

FIG. 7A illustrates the learning rate as a function over time wherein the learning rate is a function of α over a time t. FIG. 7A is the traditional learning rate function α over time. From time t=0 to t=t₁, the learning rate α is linearly increasing over the function of time. For a linearly increasing learning rate α, the language model rapidly updates the model's parameters and weights to optimize convergence of the language model. For time t=t₁ to t=t₃, the learning rate α is inversely decreasing over a function of time. For an inversely decreasing learning rate α, the language model progressively decreases a step size during training, enabling fine-grained parameter adjustments towards the convergence of an optimal solution. For time t=t₃ to t=t₄, the learning rate α is linearly decreasing over a function of time. For an linearly decreasing learning rate α, the language model significantly decreases step size during training towards the convergence of the optimal solution.

FIG. 7B also illustrates the learning rate as a function over time wherein the learning rate is a function of α over a time t. FIG. 7B determines learning rate function α over time for a language model. From time t=0 to t=t₁, with a set of iterations S1 710, the learning rate α is linearly increasing over the function of time. For time t=t₁ to t=t₂, with a set of iterations S2 720, the learning rate α is inversely decreasing and a constant value c with respect to the number of iterations. For an inversely decreasing learning rate α, the language model progressively decreases a step size during training, enabling fine-grained parameter adjustments towards the constant value. For time t=t₂ to t=t₄, with a set of iterations S3 730, the learning rate α is linearly decreasing over a function of time. For a linearly decreasing learning rate α, the language model significantly decreases step size during training towards the convergence of an optimal solution. According to an embodiment, the set S3 of iterations has greater than 10% and less than 40% of a total number of iterations.

### Process of Training of Machine Learning Models

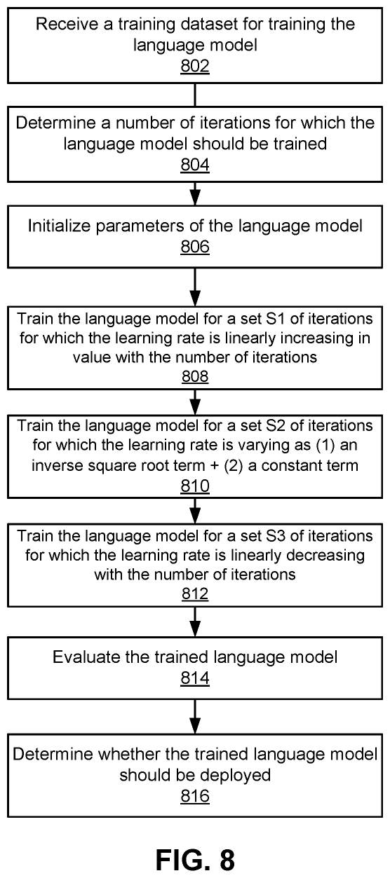

FIG. 8 is a flowchart of a method for a model training module 560, in accordance with an embodiment. The process shown in FIG. 8 may be performed by one or more components (e.g., the control layer 106) of a data processing system/service (e.g., the data processing service 102). Other entities may perform some or all of the steps in FIG. 8. The data processing service 102 as well as the other entities may include some or more of the component of the machine (e.g., computer system) described in conjunction with FIG. 9. Embodiments may include different and/or additional steps, or perform the steps in different orders. A model training module 560 receive 802 a training dataset for training a learning model. The model training module 560 determine 804 a number of iterations for which the language model should be trained and initialize 806 parameters of the language model. The model training module 560 trains 808 the language model for a set S1 of iterations for which the learning rate is linearly increasing in value with the number of iterations. The model training module 560 trains 810 the language model for a set S2 of iterations for which the learning rate is varying as an inverse square root term and constant term with the number of iterations. The model training module 560 trains 812 the language model for a set S3 of iterations for which the learning rate is linearly decreasing with the number of iterations. The model training module 560 evaluates 814 the trained language model and determines 816 whether the trained language model should be deployed.

FIG. 9 is a flowchart of a method for the learning rate module 610 when a language model is repeatedly re-trained, in accordance with an embodiment. The learning rate module 610 determines 910 based on an evaluation of the language model that the language model needs further training. For example, based on execution of the language model using a subset of the training data determined to model evaluation, the model training module 560 may determine that the loss value determined indicates that the language model needs further training. Responsive to determining that the language model needs further training, the learning rate module 610 determines 920 a number of iterations for subsequent training of the language model and trains 930 the language model for that determined number of iterations. The number of iterations for which the model is trained includes a set S2′ of iterations and a set S3′ of iterations. The model training module 560 trains the language model for a set S2′ of iterations for which the learning rate varies with the number of iterations as function comprising a (1) a first term which is an inverse square root of the number of a current iteration of training and (2) a constant term. After the language model is trained for the S2′ set of iterations, the model training module 560 trains 940 the language model for a set S3′ of iterations for which the learning rate is linearly decreasing with the number of iteration for the S3′ number of iterations. The process of FIG. 9 may be repeated multiple times until the evaluation of the language model indicates that additional training is not required.

Turning now to FIG. 10, illustrated is an example machine to read and execute computer readable instructions, in accordance with an embodiment. Specifically, FIG. 10 shows a diagrammatic representation of the data processing service 102 (and/or data processing system) in the example form of a computer system 1000. The computer system 1000 is structured and configured to operate through one or more other systems (or subsystems) as described herein. The computer system 1000 can be used to execute instructions 1024 (e.g., program code or software) for causing the machine (or some or all of the components thereof) to perform any one or more of the methodologies (or processes) described herein. In executing the instructions, the computer system 1000 operates in a specific manner as per the functionality described. The computer system 1000 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 1000 may be a server computer, a client computer, a personal computer (PC), a tablet PC, a smartphone, an internet of things (IoT) appliance, a network router, switch or bridge, or other machine capable of executing instructions 1024 (sequential or otherwise) that enable actions as set forth by the instructions 1024. Further, while only a single machine is illustrated, the term “machine” shall also be taken to include any collection of machines that individually or jointly execute instructions 1024 to perform any one or more of the methodologies discussed herein.

The example computer system 700 includes a processing system 1002. The processor system 1002 includes one or more processors. The processor system 1002 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor system 1002 executes an operating system for the computing system 1000. The computer system 1000 also includes a memory system 1004. The memory system 1004 may include or more memories (e.g., dynamic random access memory (RAM), static RAM, cache memory). The computer system 1000 may include a storage system 1016 that includes one or more machine readable storage devices (e.g., magnetic disk drive, optical disk drive, solid state memory disk drive).

The storage unit 716 stores instructions 724 (e.g., software) embodying any one or more of the methodologies or functions described herein. For example, the instructions 724 may include instructions for implementing the functionalities of the transaction module 330 and/or the file management module 335. The instructions 1024 may also reside, completely or at least partially, within the memory system 1004 or within the processing system 1002 (e.g., within a processor cache memory) during execution thereof by the computer system 700, the main memory 1004 and the processor system 1002 also constituting machine-readable media. The instructions 1024 may be transmitted or received over a network 1026, such as the network 1026, via the network interface device 1020.

The storage system 1016 should be taken to include a single medium or multiple media (e.g., a centralized or distributed database, or associated caches and servers communicatively coupled through the network interface system 1020) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 1000 can include a display system 1010. The display system 1010 may driver firmware (or code) to enable rendering on one or more visual devices, e.g., drive a plasma display panel (PDP), a liquid crystal display (LCD), or a projector. The computer system 1000 also may include one or more input/output systems 1012. The input/output (IO) systems 1012 may include input devices (e.g., a keyboard, mouse (or trackpad), a pen (or stylus), microphone) or output devices (e.g., a speaker). The computer system 1000 also may include a network interface system 1020. The network interface system 1020 may include one or more network devices that are configured to communicate with an external network 1026. The external network 1026 may be a wired (e.g., ethernet) or wireless (e.g., WiFi, BLUETOOTH, near field communication (NFC).

The processor system 1002, the memory system 1004, the storage system 1016, the display system 1010, the IO systems 1012, and the network interface system 1020 are communicatively coupled via a computing bus 1008.

### Additional Considerations

The foregoing description of the embodiments of the disclosed subject matter have been presented for the purpose of illustration; it is not intended to be exhaustive or to limit the disclosed embodiments to the precise forms disclosed. Persons skilled in the relevant art can appreciate that many modifications and variations are possible in light of the disclosed subject matter.

Some portions of this description describe various embodiments of the disclosed subject matter in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosed subject matter may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosed embodiments be limited not by this detailed description, but rather by any claims that issue on an application based hereon. Accordingly, the disclosure of the embodiments of the disclosed subject matter is intended to be illustrative, but not limiting, of the scope of the subject matter, which is set forth in the following claims.

1. A method of training a language model, the method comprising:
receiving a training data set for training the language model;
determining a number of iterations for which the language model should be trained;
initializing parameters of the language model;
repeatedly training the language model for a set of iterations, wherein a learning rate of training is a piecewise function, the training comprising:
training the language model for a first set of iterations for which the learning rate is linearly increasing in value with the number of iterations;
training the language model for a second set of iterations after the first set of iterations, for which the learning rate comprises:
a first term that varies as inverse square root of the number of iterations, and
a second term that has a constant value with respect to the number of iterations; and
training the language model for a third set of iterations after the second set of iterations for which the learning rate is linearly decreasing in value with the number of iterations;
evaluating the trained language model; and
determining based on the evaluation, whether the trained language model should be deployed.

2. The method of claim 1, further comprising:
determining based on the evaluation, that the trained language model is ready to be deployed; and
deploying the trained language model.

3. The method of claim 1, wherein the third set of iterations has greater than 10% and less than 40% of a total number of iterations.

4. The method of claim 1, further comprising:
determining based on the evaluation, that the trained language model needs further training.

5. The method of claim 4, wherein the number of iterations is a first number of iterations, the method further comprising:
determining a second number of iterations for which the language model should be further trained; and
repeatedly training the language model for a second set of iterations, wherein the learning rate of training is a piecewise function comprising:
a fourth set of iterations after the third set of iterations for which the learning rate comprises:
the first term that varies as inverse square root of the number of iterations, and
the second term that has the constant value with respect to the number of iterations; and
a fifth set of iterations for which the learning rate is linearly decreasing in value with the number of iterations.

6. The method of claim 5, further comprising:
evaluating the language model; and
determining based on the evaluation, whether the trained language model should be deployed.

7. The method of claim 1, further comprising, repeating one or more times:
determining an additional number of iterations for which the language model should be further trained;
training the language model for the additional number of iterations; and
evaluating the language model.

8. The method of claim 1, further comprising repeating one or more times:
determining an additional number of iterations for which the language model should be further trained;
training the language model for the additional number of iterations, wherein the learning rate of training is a piecewise function comprising:
a fourth set of iterations after the third set of iterations for which the learning rate comprises:
the first term that varies as inverse square root of the number of iterations, and
the second term that has the constant value with respect to the number of iterations; and
a fifth set of iterations for which the learning rate is linearly decreasing in value with the number of iterations; and
evaluating the language model.

9. A non-transitory computer readable storage medium comprising stored instructions that when executed by one or more computer processors cause the one or more computer processors to:
receive a training data set for training a language model;
determine a number of iterations for which the language model should be trained;
initialize parameters of the language model;
repeatedly train the language model for a set of iterations, wherein a learning rate of training is a piecewise function, the training comprising:
train the language model for a first set of iterations for which the learning rate is linearly increasing in value with the number of iterations;
train the language model for a second set of iterations after the first set of iterations, for which the learning rate comprises:
a first term that varies as inverse square root of the number of iterations, and
a second term that has a constant value with respect to the number of iterations; and
train the language model for a third set of iterations after the second set of iterations for which the learning rate is linearly decreasing in value with the number of iterations;
evaluate the trained language model; and
determine based on the evaluation, whether the trained language model should be deployed.

10. The non-transitory computer readable storage medium of claim 9, wherein the stored instructions further cause the one or more computer processors to repeatedly:
determine based on the evaluation, that the trained language model is ready to be deployed; and
deploy the trained language model.

11. The non-transitory computer readable storage medium of claim 9, wherein the third set of iterations has greater than 10% and less than 40% of a total number of iterations.

12. The non-transitory computer readable storage medium of claim 9, wherein the stored instructions further cause the one or more computer processors to repeatedly:
determine based on the evaluation, that the trained language model needs further training.

13. The non-transitory computer readable storage medium of claim 12, wherein the number of iterations is a first number of iterations, wherein the stored instructions further cause the one or more computer processors to:
determine a second number of iterations for which the language model should be further trained; and
repeatedly train the language model for a second set of iterations, wherein the learning rate of training is a piecewise function comprising:
a fourth set of iterations after the third set of iterations for which the learning rate comprises:
the first term that varies as inverse square root of the number of iterations, and
the second term that has the constant value with respect to the number of iterations; and
a fifth set of iterations for which the learning rate is linearly decreasing in value with the number of iterations.

14. The non-transitory computer readable storage medium of claim 13, wherein the stored instructions further cause the one or more computer processors to:
evaluate the trained language model; and
determine based on the evaluation, whether the trained language model should be deployed.

15. The non-transitory computer readable storage medium of claim 9, wherein the stored instructions further cause the one or more computer processors to repeatedly:
determine an additional number of iterations for which the language model should be further trained;
train the language model for the additional number of iterations; and
evaluate the language model.

16. The non-transitory computer readable storage medium of claim 9, wherein the stored instructions further cause the one or more computer processors to repeatedly:
determine an additional number of iterations for which the language model should be further trained; and
train the language model for the additional number of iterations, wherein the learning rate of training is a piecewise function comprising:
a fourth set of iterations after the third set of iterations for which the learning rate comprises:
the first term that varies as inverse square root of the number of iterations, and
the second term that has the constant value with respect to the number of iterations; and
a fifth set of iterations for which the learning rate is linearly decreasing in value with the number of iterations; and
evaluate the language model.

17. A computer system comprising:
one or more computer processors; and
a non-transitory computer readable storage medium comprising stored program code, the stored program code comprising instructions, the stored instructions when executed cause the one or more computer processors to:
receive a training data set for training a language model;
determine a number of iterations for which the language model should be trained;
initialize parameters of the language model;
repeatedly train the language model for a set of iterations, wherein a learning rate of training is a piecewise function, the training comprising:
train the language model for a first set of iterations for which the learning rate is linearly increasing in value with the number of iterations;
train the language model for a second set of iterations after the first set of iterations, for which the learning rate comprises:
a first term that varies as inverse square root of the number of iterations, and
a second term that has a constant value with respect to the number of iterations; and
train the language model for a third set of iterations after the second set of iterations for which the learning rate is linearly decreasing in value with the number of iterations;
evaluate the trained language model; and
determine based on the evaluation, whether the trained language model should be deployed.

18. The computer system of claim 17, wherein the number of iterations is a first number of iterations, wherein the stored instructions further cause the one or more computer processors to:
determine based on the evaluation, that the trained language model needs further training;
determine a second number of iterations for which the language model should be further trained;
repeatedly train the language model for a second set of iterations, wherein the learning rate of training is a piecewise function comprising:
a fourth set of iterations after the third set of iterations for which the learning rate comprises:
the first term that varies as inverse square root of the number of iterations, and
the second term that has the constant value with respect to the number of iterations; and
a fifth set of iterations for which the learning rate is linearly decreasing in value with the number of iterations.

19. The computer system of claim 17, wherein the stored instructions further cause the one or more computer processors to repeatedly:
determine an additional number of iterations for which the language model should be further trained;
train the language model for the additional number of iterations; and
evaluate the language model.

20. The computer system of claim 17, wherein the stored instructions further cause the one or more computer processors to repeatedly:
determining an additional number of iterations for which the language model should be further trained;
training the language model for the additional number of iterations, wherein the learning rate of training is a piecewise function comprising:
a fourth set of iterations after the third set of iterations for which the learning rate comprises:
the first term that varies as inverse square root of the number of iterations, and
the second term that has the constant value with respect to the number of iterations; and
a fifth set of iterations for which the learning rate is linearly decreasing in value with the number of iterations; and
evaluating the language model.
